(19) United States
(12) Patent Application Publication
(10) Pub. No.: US 2012/0066141 A1
(43) Pub. Date: Mar. 15, 2012

(54) System and Method for Conducting a Computer-Aided Telephone Interview

(75) Inventor: Michael James Williams, Edmonton (CA)

(73) Assignee: ADVANIS, INC., Edmonton (CA)

(21) Appl. No.: 13/212,417

(22) Filed: Aug. 18, 2011

Related U.S. Application Data
(60) Provisional application No. 61/375,677, filed on Aug. 20, 2010.

(51) Int. Cl. G06Q 10/06

(52) U.S. Cl. 705/321

(57) ABSTRACT

A system and method is provided for a computer-aided telephone interview system that includes a computer server operatively connected to an interviewer over a global telecommunications network, where the server is configured to transmit sound file prompts that can include pre-recorded questions and statements to a person being interviewed over a telephone network under the control of the interviewer in response to answers provided by the person being interviewed.

### CROSS-REFERENCE TO RELATED APPLICATIONS

This application claims priority of U.S. provisional patent application Ser. No. 61/375,677 filed Aug. 20, 2010, and hereby incorporates the same provisional application by reference herein in its entirety.

### TECHNICAL FIELD

The present disclosure is related to the field of telephone interview systems, in particular, computer-aided telephone interview (“CATI”) systems.

### BACKGROUND

In a typical CATI system, if a remote interviewer is used, the remote interviewer would call a respondent interviewee directly or they would connect to a central telephone system that would then call the respondent and conference in the interviewer. In both cases, a phone connection is necessary from the interviewer to the respondent. This can be achieved using a traditional telephone system or a voice over internet protocol (“VOIP”) system.

Computer-aided telephone interviews can occur when an interviewer signs into a CATI software system to complete telephone interviews by reading the script to the respondent interviewee and recording their responses into the CATI system. Traditionally, interviewers can travel to a central location call center where they are assigned a station that has a computer terminal or personal computer as well as a telephone. The dialing of the respondent can be either manual, where the interviewer reads the number off the computer screen and enters it into the phone keypad, or it can be automatic where the system dials and hangs up the phone automatically. In either case, the interviewer typically has a headset with a microphone to improve quality.

In a remote CATI environment, the interviewer does not travel to a central call center; they can work from home or some other location. In this case, the interviewer can either dial the respondent directly or connect to a central phone system that does the dialing and conferencing of the interviewer into a separate call to the respondent. This later approach allows for better monitoring and recording of the call between the interviewer and the respondent. In either case, the interviewer needs to use a telephone to communicate with the respondent.

The basic problem is how to make it cost effective to have interviewers located outside Canada or the US use a CATI system and deliver a service that is as good or better than using interviewers located in Canada or the US. One challenge with using with interviewers located in countries outside Canada or the US is that the telephone long distance charges are much higher than in Canada. Typically, long distance charges are typically $0.005 to $0.01 per minute in Canada while it would be over $0.10 per minute for most countries outside Canada and the US. The quality of the speech from interviewers located outside of Canada or the US is also typically lower than interviewers located in Canada or the US. This can be caused by the interviewers having strong accents and/or lower telephone line quality.

It is, therefore, desirable to reduce the cost of the telephone charges to conduct telephone interviews, and to improve the quality of the speech that the respondent hears from an interviewer located outside of Canada or the US.

### SUMMARY

A system and method for conducting a computer-aided telephone interview (“CATI”) is provided. In some embodiments, the need for a telephone phone connection between the interviewer and the respondent (also referred to herein as “interviewee”) who is to be interviewed can be eliminated. A telephone connection from a CATI system server to the respondent is still required. This method can be achieved by sending commands from an interviewer agent, specifically, commands from software on the agent's computer to the CATI system server to command the CATI system server to play prompts or sound files to the respondent, and to the interviewer at the same time. The responses from the respondent can then be received by the CATI system server. The CATI system server can then transmit the active speech to the agent computer. In some embodiments, the CATI system server can remove the silence when the respondent sound responses are played to the agent.

Instead of having the interviewer read the prompts to the respondent, the interviewer agent can, instead, use their computer to select the sound file prompt to be played by the CATI system server to the respondent over the telephone connection between the CATI system server and the respondent. This can result in sound quality that is higher than typical interviewers as the telephone connection is just between the respondent and the CATI system server, which can be located in the same country as the respondent. A telephone connection to the interviewer agent, who can be located in another country, is not necessary. Accordingly, the telephone costs associated with a telephone connection with the interviewer agent can be reduced or eliminated altogether.

In some embodiments, the system and method described herein can be commenced by an interviewer signing into a CATI system, and recording the respondent responses in the same way as a normal CATI system. However, rather than reading the script to the respondent, the interviewer can use a computer-aided interface to cause a central phone system operatively connected to the CATI system server to play pre-recorded sound file prompts to the respondent. The interviewer can still hear what the respondent is saying except that the agent can hear the response through their computer rather than through a telephone connection with the respondent.

In some embodiments, the method can comprise of the following steps. First, the CATI system server can authenticate an interviewer. Once authenticated, the interviewer agent can select a project that has a list of respondents who are to be interviewed. In some embodiments of the system, all the pre-recorded sound prompt files can be transmitted to the client software located on the interviewer's computer. The CATI system can then dial respondents until a respondent answers the phone. The response from the respondent can be transmitted to the interviewer's computer where it can be played on the computer's speaker. In some embodiments, only the speech of the respondent is transmitted rather than the silence when the respondent is talking. Silence is not transmitted to minimize the bandwidth requirements and amount of data transmitted to the interviewer's computer from the CATI system server. If silence is detected, then white noise can be played on the interviewer's computer to indicate to the interviewer that the connection with the respondent is still active.

At the start of the call, any recordings such as the name of the respondent or a date can be sent to the client software running on the interviewer's computer so that these recordings can be merged into the standard pre-recorded sound file prompts. After listening to the response of the respondent, the Interviewer can select the appropriate response from a list of pre-recorded sound file prompts and press the appropriate keys on their computer to notify the CATI system server which sound file prompt to play to the respondent.

Once the interviewer has selected the sound file prompt, the CATI system server can play the sound file prompt to the respondent. At the same time, the client software running on the interviewer's computer that sent the command to the CATI system server can also play the prompt to the interviewer using their computer's speaker. The CATI system server can also record all the responses from the respondent and the commands from the interviewer's computer to start and stop the playing of pre-recorded sound file prompts. Complete recordings of the conversation can be generated for quality assurance and monitoring purposes. In addition to controlling the pre-recorded sound file prompts that are played to the respondent interviewee, the interviewer can also control the style of the sound file prompts. The style can include attributes such as the speed of the speech, the volume and the tone. Depending on the features required, this functionality can be achieved using multiple versions of the recordings or by modifying the sound file programmatically. In all cases, the information content can be essentially the same.

Broadly stated, in some embodiments, a computer-aided telephone interview system is provided, comprising: a system server configured to establish a telecommunications link to an interviewee over a public switched telephone network; the system server configured to play at least one pre-recorded sound file prompt over the telecommunications link to the interviewee, and to receive responses from the interviewee over the telecommunications link; the system server operatively connected to an agent computer over a global telecommunications network, the system server configured to transmit responses received from the interviewee to the interviewer agent computer to be played to an interviewer; and the interviewer agent computer configured to transmit commands to the system server to play at least one pre-recorded sound file prompt to the interviewee.

Broadly stated, in some embodiments, a method is provided for conducting a computer-aided telephone interview, the method comprising the steps of: establishing a connection between an interviewer agent computer to a system server over a global telecommunications network; establishing a telecommunications link between the system server and an interviewee over a public switched telephone network; transmitting a command from the interviewer agent computer to the system server to play at least one pre-recorded sound file prompt to the interviewee over the telecommunications link; and upon receiving a response from the interviewee to the at least one pre-recorded sound file prompt, transmitting the response from the system server to the interviewer agent computer.

Broadly stated, in some embodiments, a system is provided for conducting a computer-aided telephone interview, comprising: means for establishing a connection between an interviewer agent computer to a system server over a global telecommunications network; means for establishing a telecommunications link between the system server and an interviewee over a public switched telephone network; means for transmitting a command from the interviewer agent computer to the system server to play at least one pre-recorded sound file prompt to the interviewee over the telecommunications link; and means for transmitting the response from the system server to the interviewer agent computer upon receiving a response from the interviewee to the at least one pre-recorded sound file prompt.

Broadly stated, in some embodiments, a method is provided for conducting a computer-aided telephone interview, the method comprising the steps of: providing a system server configured to establish a telecommunications link to an interviewee over a public switched telephone network, the system server configured to play at least one pre-recorded sound file prompt over the telecommunications link to the interviewee and to receive responses from the interviewee over the telecommunication link; providing an interviewer agent computer, the interviewer agent computer operatively connected to the system server over a global telecommunications network, the system server configured to transmit responses received from the interviewee to the interviewer agent computer to be played to an interviewer; carrying out an agent session login process on the interviewer agent computer; carrying out a call setup process on the system server; and processing the call.

Broadly stated, in some embodiments, a system is provided for conducting a computer-aided telephone interview, comprising: a system server configured to establish a telecommunications link to an interviewee over a public switched telephone network, the system server configured to play at least one pre-recorded sound file prompt over the telecommunications link to the interviewee and to receive responses from the interviewee over the telecommunication link; an interviewer agent computer, the interviewer agent computer operatively connected to the system server over a global telecommunications network, the system server configured to transmit responses received from the interviewee to the interviewer agent computer to be played to an interviewer; means for carrying out an agent session login process on the interviewer agent computer; means for carrying out a call setup process on the system server; and means for processing the call.

Broadly stated, in some embodiments, a method is provided for conducting a computer-aided telephone interview on a system comprising a system server configured to establish a telecommunications link to an interviewee over a public switched telephone network, the system server configured to operatively connect to an interviewer agent computer over a global telecommunications network, the method being embodied on a computer-readable medium such that, when implemented on the system server, the method permits the conducting of the computer-aided telephone interview with the interviewee, the computer-readable medium comprising: a code segment that establishes a connection between the system server to the interviewer agent computer over the global telecommunications network; a code segment that establishes the telecommunications link between the system server and the interviewee over the public switched telephone network; a code segment that receives a command from the interviewer agent computer to play at least one pre-recorded sound file prompt to the interviewee over the telecommunications link; and a code segment that, upon the system server receiving a response from the interviewee to the at least one pre-recorded sound file prompt, transmits the response from the system server to the interviewer agent computer. In further embodiments, the computer-readable medium can further comprise a code segment that authenticates the interviewer agent computer. In further embodiments, the computer-readable medium can further comprise a code segment that selects a project comprising a list of interviewees to be interviewed. In further embodiments, the computer-readable medium can further comprise a code segment that plays another of the at least one pre-recorded sound file prompt to the interviewee over the telecommunications link after receiving the interviewee's response. In further embodiments, the computer-readable medium can further comprise a code segment that records at least one of the responses of the interviewee and at least one of the commands received from the interviewer agent computer to play the at least one pre-recorded sound file prompt. In further embodiments, the computer-readable medium can further comprise a code segment that controls at least one attribute of the at least one pre-recorded sound file prompt.

Broadly stated, in some embodiments, a method is provided for conducting a computer-aided telephone interview on a system comprising a system server configured to establish a telecommunications link to an interviewee over a public switched telephone network, the system server configured to operatively connect to an interviewer agent computer over a global telecommunications network, the method being embodied on a computer-readable medium such that, when implemented on the system, the method permits the conducting of the computer-aided telephone interview with the interviewee, the computer-readable medium comprising: a code segment that carries out an interviewer agent login process; a code segment that carries out a call setup process; and a code segment that processes the call. In further embodiments, the computer-readable medium can further comprise code segments that authenticate the interviewer agent computer, display at least project comprising a list of interviewees to be interviewed; selects the at least one project, download one or more sound files associated with the at least one project from the system server to the interviewer agent computer, and notify the system server that the interviewer agent computer is ready to accept a call. In further embodiments, the computer-readable medium can further comprise a code segment that updates a list of valid project agents. In further embodiments, the computer-readable medium can further comprise code segments that obtains a project phone number, dials and makes a call to the project phone number, and if the call to the project phone number is answered, selects a valid interviewer agent to handle the call, and if the call is not answered, hangs up the call and obtains another project phone number. In further embodiments, the computer-readable medium can further comprise code segments that transmits sound received by the system server from the interviewee to the interviewer agent computer, sends a question specification to the interviewer agent computer, displays a question and the interviewee's response to the question on the interviewer agent computer, plays the sound on the interviewer agent computer, selects a question response to the interviewee's response, and sends a command to the system server to play a pre-recorded sound file prompt associated with the question response to the interviewee. In further embodiments, the computer-readable medium can further comprise a code segment that plays the pre-recorded sound file prompt on the interviewer agent computer. In further embodiments, the computer-readable medium can further comprise a code segment that repeats the foregoing steps until a survey with the interviewee has been completed and ends the call.

### BRIEF DESCRIPTION OF THE DRAWINGS

FIG. 1 is a block diagram depicting one embodiment of a computer-aided telephone interview system.

FIG. 2 is a block diagram depicting another embodiment of a computer-aided telephone interview system.

FIG. 3 is a flowchart depicting the steps of an agent session login process of a computer-aided telephone interview system.

FIG. 4 is a flowchart depicting the steps of a call setup process of a computer-aided telephone interview system.

FIG. 5 is a flowchart depicting the steps of a call processing process of a computer-aided telephone interview system.

### DETAILED DESCRIPTION OF EMBODIMENTS

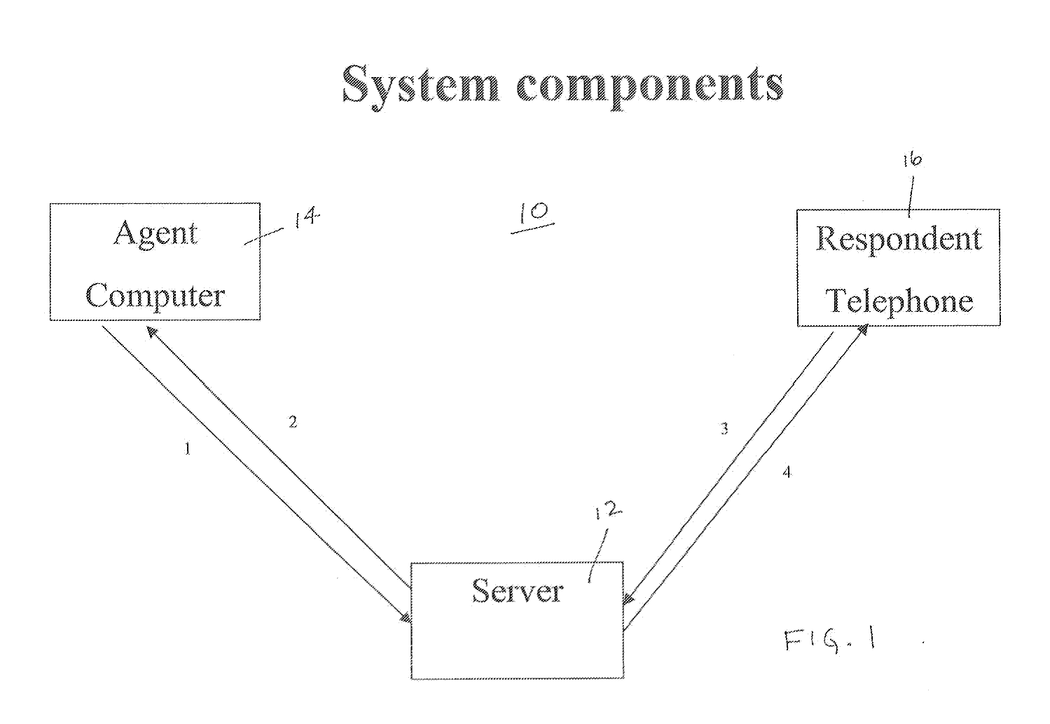

Referring to FIG. 1, one embodiment of a basic CATI system is shown. In some embodiments, CATI system 10 can comprise server 12 operatively connected to interviewer or agent computer 14 and to interviewee or respondent telephone 16. In some, embodiments, link 1 disposed between agent computer 14 and server 12 can be used to send commands from computer 14 to server 12 to control the pre-recorded sound file prompts transmitted to and played on respondent telephone 16 or to control the phone connection to respondent telephone 16 (for example: dial, hang up, transfer, etc). In some embodiments, agent compute 14 can comprise a general-purpose personal computer, as well known to those skilled in the art. Agent computer 14 can further comprise sound generation means, such as a sound card and speakers, to play back the pre-recorded sound file prompts, and the responses from the interviewees. Agent computer 14 can further comprise a microphone for the interviewer to speak to the interviewee.

In some embodiments, link 2 disposed between agent computer 14 and server 12 can be used to transmit the sound from respondent telephone 16 to agent computer 14 when the responding is speaking. In some embodiments, link 2 does not transmit silence or an absence of sound or speech from respondent telephone 16.

In some embodiments, link 1 and link 2 can be disposed on an internet communications link between agent computer 14 and server 12, as well known to those skilled in the art.

In some embodiments, link 3 disposed between respondent telephone 16 and server 12 can be used to carry sound or speech transmitted from the respondent to server 12. In some embodiments, link 4 disposed between respondent telephone 16 and server 12 can be used to carry sound or speech comprising of questions or statements transmitted to the respondent from server 12. In some embodiments, link 3 and link 4 can be disposed on a telephone communication line between server 12 and respondent telephone 16, such as those routed through a public switched telephone network as one example or its equivalent, as well known to those skilled in the art.

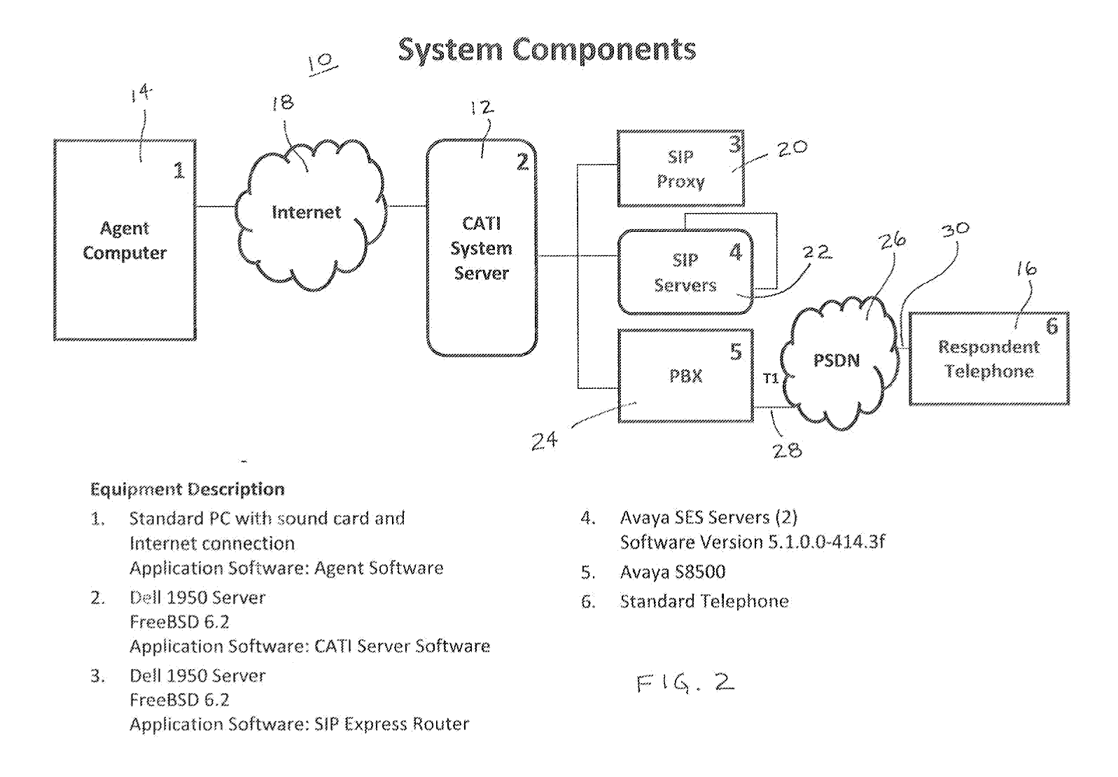

Referring to FIG. 2, another embodiment of CATI system 10 is illustrated. In some embodiments, agent computer 14 can be in communication with CATI system server 12 via a global telecommunications network, such as the internet as shown as reference numeral 18 in FIG. 2. Server 12 can be operatively connected to session initiation proxy (“SIP) server 20 and SIP server 22. SIP proxy server 18 and SIP server 22 can comprise Avaya SES Servers operating with software version 5.1.0.0-414.3f, as manufactured by Avaya Inc. of 211 Mt. Airy Road, Basking Ridge, N.J. 07920, U.S.A.

In some embodiments, CATI system server 12 can be operatively connected to telephone switch or PBX 24 (as shown in FIG. 2), which can be a private branch exchange (“PBX”) or a private automatic branch exchange (“PABX”) as well known to those skilled in the art. A representative example of PBX 24 can be the Avaya S8500 PBX, as manufactured by Avaya Inc.

In some embodiments, PBX 24 can be operatively connected to a public switched telephone network or a public switched data network via digital communications link 28. In a representative embodiment, communications link 28 can be a 1.544 Mb/s T-1 digital link connected to public switched data network (“PSDN”) 26 although it is obvious to those skilled in the art that communications link 28 can comprise any suitable digital data rate (e.g., E-1, T-2, T-3, T-4, etc.) and that PSDN 26 can comprise any suitable digital telephone switch that is connected to a public switched telephone network (“PSTN”), depending on the volume of calls that CATI system 10 is configured to handle and the communication protocols used in the PSTN in the country or geographical region where CATI system 10 is located or operating through.

In some embodiments, respondent telephone 16 can be operatively connected to PSDN 26 via telecommunications link 30. It is obvious to those skilled in the art that telecommunications link 30 can comprise any known telephone transmission equipment configured to provide plain old telephone service (“POTS”) to an end user's telephone. This equipment can comprise a twisted copper pair line running from respondent telephone 16 to a local central telephone office or the equipment can comprise a loop carrier system as well known to those skilled in the art to provide POTS to respondent telephone 16 from the nearest PSTN central office.

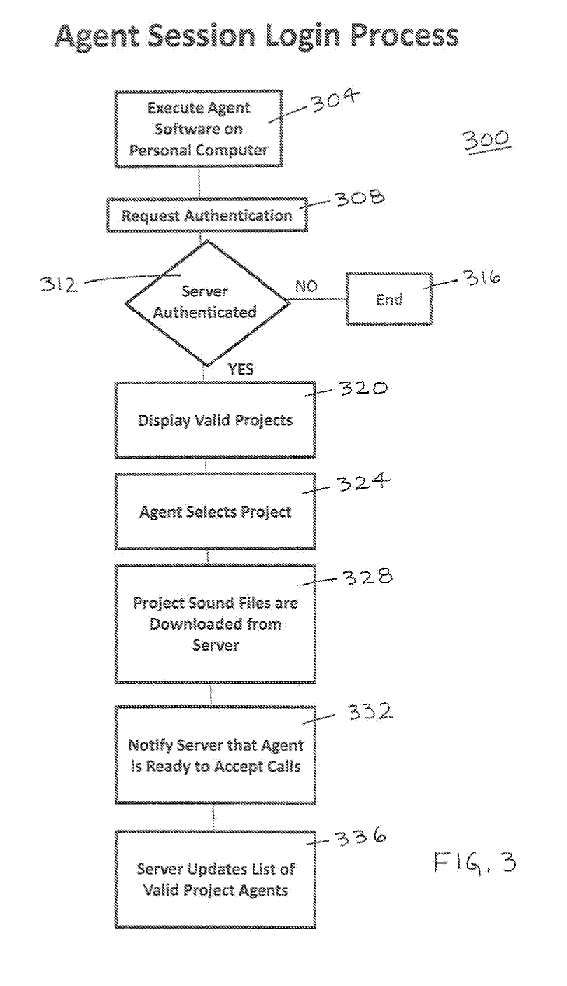

In order for agent computer 14 to operate within CATI system 10 to carry out a computer-aided telephone interview, agent computer 14 can comprise computer software configured to enable this functionality. In some embodiments, the computer software disposed on agent computer 14 can be configured to carry out agent session login process 300, as shown in FIG. 3. Process 300 can start with step 304, where an agent can execute the Agent software on agent computer 14. At step 308, the agent can enter their username and password to authenticate the agent as an authorized user of CATI system 10. The Agent software can send a command to server 12 that contains the username and password for the agent. At step 312, server 12 responses with a success or failure to authenticate the agent. If the authentication step fails, process 300 ends at step 316. If the Agent software is successful in authenticating, then a list of projects that this agent has access to can be sent from server 12 to the Agent software on agent computer 14 at step 320.

At step 324, the Agent can select the project they would like to work on from a dropdown list. At step 328, the Agent Software can send a command to server 12 to request the project sound files. In some embodiments, server 12 can send the sound files to the Agent software on agent computer 14, whereby these sound files can be stored in memory rather than on a disk. At step 332, the Agent software can send a command to server 12 to inform it that the Agent is ready to accept calls. At step 336, server 12 can add the agent to the list of agents that can handle calls for this project. In some embodiments, server 12 can call phone numbers for this project as long as there are agents assigned to the project. At this point, a call setup process to connect the agent to an interviewee listed in the project can be commenced.

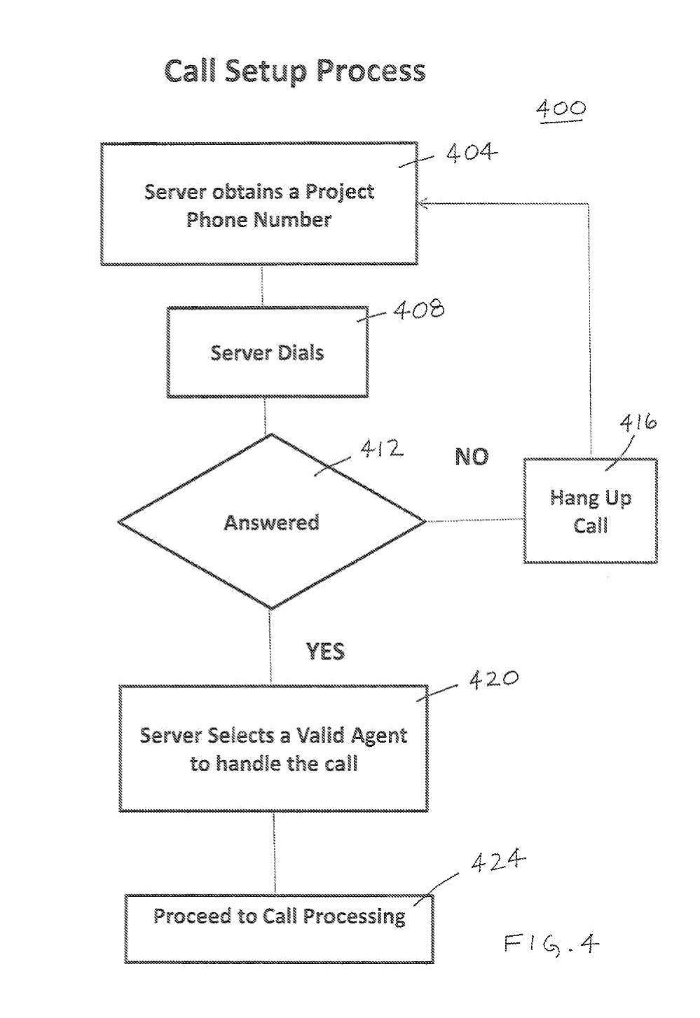

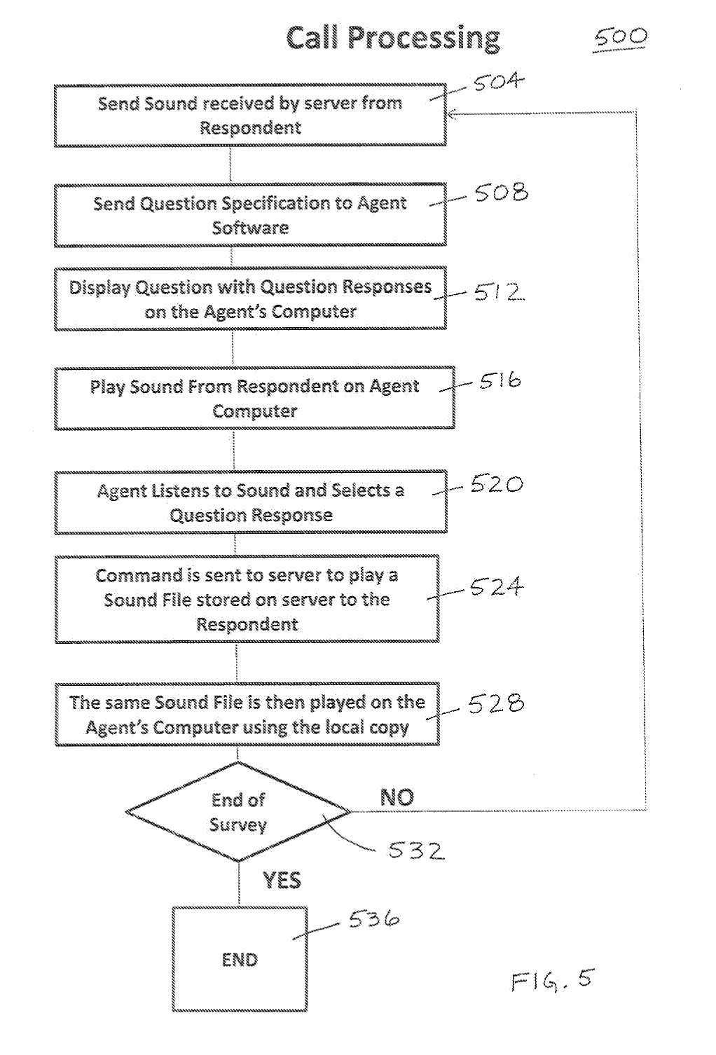

Referring to FIG. 4, the steps of one embodiment of call setup process 400 is shown. At step 404, server 12 can obtain an interviewee's telephone number to be dialed. The interviewee's telephone number is dialed at step 408. At step 412, server 12 can determine whether the interviewee answers the telephone call set up between PBX 24 and telephone 16. If there is no answer, the call is terminated at step 416, and process 400 can return to step 404 to select the telephone number of another interviewee listed in the project. If the interviewee answers the call, server 12 can select a valid agent to handle the call and send the sound of the respondent interviewee answering the call to the Agent at step 420. Process 400 can then proceed, at step 424, to call processing process 500 as shown in FIG. 5.

Referring to FIG. 5, server 12 can send sound or speech received from the respondent interviewee to agent computer 14 at step 504. At step 508, a question specification can be sent from server 12 to the Agent software on agent computer 14. At step 512, the Agent software can display a question with a list of responses for the question on agent computer 14. At step 516, the Agent software on agent computer 14 can play the sound of the respondent answering using the speakers of agent computer 14. At step 520, the Agent can then select a response to play to the respondent interviewee based on what the agent heard. At step 524, a command can be sent from the Agent software on agent computer 14 to server 12 to play a specific sound file. At step 528, server 12 can play the specific sound file to the respondent interviewee through the telephone connection to respondent telephone 16. At the same time, the sound file played to the respondent is also played to the Agent using the local copy of the sound files stored in memory on agent computer 14.

At step 532, process 500 can determine whether the survey of the respondent interviewee has been completed. If the survey is not complete, process 500 can return to step 504 to repeat steps 508 through 528 for a new question posed to the respondent interviewee. If the survey has been completed, process 500 ends the call processing process at step 536.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A computer-aided telephone interview system, comprising:
a) a system server configured to establish a telecommunications link to an interviewee over a public switched telephone network;
b) the system server configured to play at least one pre-recorded sound file prompt over the telecommunications link to the interviewee, and to receive responses from the interviewee over the telecommunications link;
c) the system server operatively connected to an interviewer agent computer over a global telecommunications network, the system server configured to transmit responses received from the interviewee to the interviewer agent computer to be played to an interviewer; and
d) the interviewer agent computer configured to transmit commands to the system server to play at least one pre-recorded sound file prompt to the interviewee.

2. The system as set forth in claim 1, wherein the system server is configured to not transmit silence or an absence of sound or speech disposed in the responses of the interviewee.

3. The system as set forth in claim 1, wherein the global telecommunications network comprises the internet.

4. The system as set forth in claim 1, wherein the system further comprises a telephone switch operatively connected to the system server, the telephone switch configured to establish the telecommunications link between the system server and the public switched telephone network.

5. The system as set forth in claim 4, wherein the telephone switch comprises a private branch exchange or a private automatic branch exchange.

6. A method for conducting a computer-aided telephone interview, the method comprising the steps of:
a) establishing a connection between an interviewer agent computer to a system server over a global telecommunications network;
b) establishing a telecommunications link between the system server and an interviewee over a public switched telephone network;
c) transmitting a command from the interviewer agent computer to the system server to play at least one pre-recorded sound file prompt to the interviewee over the telecommunications link; and
d) upon receiving a response from the interviewee to the at least one pre-recorded sound file prompt, transmitting the response from the system server to the interviewer agent computer.

7. The method as set forth in claim 6, further comprising the step of authenticating the interviewer agent computer.

8. The method as set forth in claim 6, further comprising the step of selecting a project comprising a list of interviewees to be interviewed.

9. The method as set forth in claim 6, further comprising the step of playing another of the at least one pre-recorded sound file prompt to the interviewee over the telecommunications link after receiving the interviewee's response.

10. The method as set forth in claim 6, further comprising the step of recording at least one of the responses of the interviewee and at least one of the commands from the interviewer agent computer to play the at least one pre-recorded sound file prompt.

11. The method as set forth in claim 6, further comprising the step of controlling at least one attribute of the at least one pre-recorded sound file prompt.

12. The method as set forth in claim 11, wherein the at least one attribute comprises one or more of the group consisting of speed of speech, volume and tone.

13. A system for conducting a computer-aided telephone interview, comprising:
a) means for establishing a connection between an interviewer agent computer to a system server over a global telecommunications network;
b) means for establishing a telecommunications link between the system server and an interviewee over a public switched telephone network;
c) means for transmitting a command from the interviewer agent computer to the system server to play at least one pre-recorded sound file prompt to the interviewee over the telecommunications link; and
d) means for transmitting the response from the system server to the interviewer agent computer upon receiving a response from the interviewee to the at least one pre-recorded sound file prompt.

14. The system as set forth in claim 13, further comprising means for authenticating the interviewer agent computer.

15. The system as set forth in claim 13, further comprising means for selecting a project comprising a list of interviewees to be interviewed.

16. The system as set forth in claim 13, further comprising means for playing another of the at least one pre-recorded sound file prompt to the interviewee over the telecommunications link after receiving the interviewee's response.

17. The system as set forth in claim 13, further comprising means for recording all of the responses of the interviewee and all of the commands from the interviewer agent computer to play the at least one pre-recorded sound file prompt.

18. The system as set forth in claim 13, further comprising means for controlling at least one attribute of the at least one pre-recorded sound file prompt.

19. The system as set forth in claim 18, wherein the at least one attribute comprises one or more of the group consisting of speed of speech, volume and tone.

20. A method for conducting a computer-aided telephone interview, the method comprising the steps of:
a) providing a system server configured to establish a telecommunications link to an interviewee over a public switched telephone network, the system server configured to play at least one pre-recorded sound file prompt over the telecommunications link to the interviewee and to receive responses from the interviewee over the telecommunication link;
b) providing an interviewer agent computer, the interviewer agent computer operatively connected to the system server over a global telecommunications network, the system server configured to transmit responses received from the interviewee to the interviewer agent computer to be played to an interviewer;
c) carrying out an interviewer agent session login process on the interviewer agent computer;
d) carrying out a call setup process on the system server; and
e) processing the call.

21. The method as set forth in claim 20, wherein the step of carrying out the interviewer agent session login process further comprises the steps of:
a) authenticating the interviewer agent computer;
b) displaying at least one project comprising a list of interviewees to be interviewed;
c) selecting the at least one project;
d) downloading one or more sound files associated with the at least one project from the system server to the interviewer agent computer; and
e) notifying the system server that the interviewer agent computer is ready to accept a call.

22. The method as set forth in claim 21, further comprising the step of the system server updating a list of valid project agents.

23. The method as set forth in claim 20, wherein the step of carrying out the call setup process further comprises the steps of:
a) obtaining a project phone number;
b) dialing and making a call to the project phone number; and
c) if the call to the project phone number is answered, selecting a valid interviewer agent to handle the call, and if the call is not answered, hanging up the call and obtaining another project phone number.

24. The method as set forth in claim 20, wherein the step of processing the call further comprises the steps of:
a) transmitting sound received by the system server from the interviewee to the interviewer agent computer;
b) sending a question specification to the interviewer agent computer;
c) displaying a question and the interviewee's response to the question on the interviewer agent computer;
d) playing the sound on the interviewer agent computer;
e) selecting a question response to the interviewee's response; and
f) sending a command to the system server to play a pre-recorded sound file prompt associated with the question response to the interviewee.

25. The method as set forth in claim 24, further comprising the step of playing the pre-recorded sound file prompt on the interviewer agent computer.

26. The method as set forth in claim 24, further comprising the steps of repeating steps a) to f) until a survey with the interviewee has been completed, and ending the call.

27. A system for conducting a computer-aided telephone interview, comprising:
a) a system server configured to establish a telecommunications link to an interviewee over a public switched telephone network, the system server configured to play at least one pre-recorded sound file prompt over the telecommunications link to the interviewee and to receive responses from the interviewee over the telecommunication link;
b) an interviewer agent computer, the interviewer agent computer operatively connected to the system server over a global telecommunications network, the system server configured to transmit responses received from the interviewee to the interviewer agent computer to be played to an interviewer;
c) means for carrying out an interviewer agent session login process on the interviewer agent computer;
d) means for carrying out a call setup process on the system server; and
e) means for processing the call.

28. The system as set forth in claim 27, further comprising:
a) means for authenticating the interviewer agent computer;
b) means for displaying at least one project comprising a list of interviewees to be interviewed;
c) means for selecting the at least one project;
d) means for downloading one or more sound files associated with the at least one project from the system server to the interviewer agent computer; and
e) means for notifying the system server that the interviewer agent computer is ready to accept a call.

29. The system as set forth in claim 28, further comprising means for updating a list of valid project agents.

30. The system as set forth in claim 27, further comprising:
a) means for obtaining a project phone number;
b) means for dialing and making a call to the project phone number; and
c) means for selecting a valid interviewer agent to handle the call if the call to the project phone number is answered, and means for hanging up the call and obtaining another project phone number if the call is not answered.

31. The system as set forth in claim 27, further comprising:
a) means for transmitting sound received by the system server from the interviewee to the interviewer agent computer;
b) means for sending a question specification to the interviewer agent computer;
c) means for displaying a question and the interviewee's response to the question on the interviewer agent computer;
d) means for playing the sound on the interviewer agent computer;
e) means for selecting a question response to the interviewee's response; and
f) means for sending a command to the system server to play a pre-recorded sound file prompt associated with the question response to the interviewee.

32. The system as set forth in claim 31, further comprising means for playing the pre-recorded sound file prompt on the interviewer agent computer.

33. A method for conducting a computer-aided telephone interview on a system comprising a system server configured to establish a telecommunications link to an interviewee over a public switched telephone network, the system server configured to operatively connect to an interviewer agent computer over a global telecommunications network, the method being embodied on a computer-readable medium such that, when implemented on the system server, the method permits the conducting of the computer-aided telephone interview with the interviewee, the computer-readable medium comprising:
a) a code segment that establishes a connection between the system server to the interviewer agent computer over the global telecommunications network;
b) a code segment that establishes the telecommunications link between the system server and the interviewee over the public switched telephone network;
c) a code segment that receives a command from the interviewer agent computer to play at least one pre-recorded sound file prompt to the interviewee over the telecommunications link; and
d) a code segment that, upon the system server receiving a response from the interviewee to the at least one pre-recorded sound file prompt, transmits the response from the system server to the interviewer agent computer.

34. The method as set forth in claim 33, wherein the computer-readable medium further comprises a code segment that authenticates the interviewer agent computer.

35. The method as set forth in claim 33, wherein the computer-readable medium further comprises a code segment that selects a project comprising a list of interviewees to be interviewed.

36. The method as set forth in claim 33, wherein the computer-readable medium further comprises a code segment that plays another of the at least one pre-recorded sound file prompt to the interviewee over the telecommunications link after receiving the interviewee's response.

37. The method as set forth in claim 33, wherein the computer-readable medium further comprises a code segment that records at least one of the responses of the interviewee and at least one of the commands received from the interviewer agent computer to play the at least one pre-recorded sound file prompt.

38. The method as set forth in claim 33, wherein the computer-readable medium further comprises a code segment that controls at least one attribute of the at least one pre-recorded sound file prompt.

39. The method as set forth in claim 38, wherein the at least one attribute comprises one or more of the group consisting of speed of speech, volume and tone.

40. A method for conducting a computer-aided telephone interview on a system comprising a system server configured to establish a telecommunications link to an interviewee over a public switched telephone network, the system server configured to operatively connect to an interviewer agent computer over a global telecommunications network, the method being embodied on a computer-readable medium such that, when implemented on the system, the method permits the conducting of the computer-aided telephone interview with the interviewee, the computer-readable medium comprising:
a) a code segment that carries out an interviewer agent login process;
b) a code segment that carries out a call setup process; and
c) a code segment that processes the call.

41. The method as set forth in claim 40, wherein the code segment that carries out the interviewer agent login process further comprises:
a) a code segment that authenticates the interviewer agent computer;
b) a code segment that displays at least project comprising a list of interviewees to be interviewed;
c) a code segment that selects the at least one project;
d) a code segment that downloads one or more sound files associated with the at least one project from the system server to the interviewer agent computer; and
e) a code segment that notifies the system server that the interviewer agent computer is ready to accept a call.

42. The method as set forth in claim 41, further comprising a code segment that updates a list of valid project agents.

43. The method as set forth in claim 40, wherein the code segment that carries out the call setup process further comprises:
a) a code segment that obtains a project phone number;
b) a code segment that dials and makes a call to the project phone number; and
c) a code segment that, if the call to the project phone number is answered, selects a valid interviewer agent to handle the call, and if the call is not answered, hangs up the call and obtains another project phone number.

44. The method as set forth in claim 40, wherein the code segment that processes the call further comprises:
a) a code segment that transmits sound received by the system server from the interviewee to the interviewer agent computer;
b) a code segment that sends a question specification to the interviewer agent computer;
c) a code segment that displays a question and the interviewee's response to the question on the interviewer agent computer;
d) a code segment that plays the sound on the interviewer agent computer;
e) a code segment that selects a question response to the interviewee's response; and
f) a code segment that sends a command to the system server to play a pre-recorded sound file prompt associated with the question response to the interviewee.

45. The method as set forth in claim 44, further comprising a code segment that plays the pre-recorded sound file prompt on the interviewer agent computer.

46. The method as set forth in claim 44, further comprising a code segment that repeats steps a) to f) until a survey with the interviewee has been completed and ends the call.
